(19) United States
(12) Patent Application Publication
(10) Pub. No.: US 2015/0120702 A1
(43) Pub. Date: Apr. 30, 2015

(54) APPARATUS AND METHOD FOR BROWSING 3-DIMENSIONAL CONTENT

(71) Applicant: Electronics and Telecommunications Research Institute, Daejeon (KR)

(72) Inventors: Hyung Il SUH, Seoul (KR); Yun Kyung PARK, Daejeon (KR); Jong Hyun PARK, Daejeon (KR)

(73) Assignee: Electronics and Telecommunications Research Institute, Daejeon (KR)

(21) Appl. No.: 14/226,310

(22) Filed: Mar. 26, 2014

(30) Foreign Application Priority Data
Oct. 29, 2013 (KR) 10-2013-0129102

(51) Int. Cl. G06F 17/30

(52) U.S. Cl. CPC G06F 17/30572; G06F 17/30554
USPC 707/722

(57) ABSTRACT

Provided are an apparatus and method for browsing content in a 3D space. The 3D content browsing apparatus includes an input unit configured to receive content including metadata or a command, a content storage unit configured to receive and store the content input through the input unit, a content calling unit configured to receive a content retrieval command input through the input unit and call the content stored in the content storage unit on the basis of the content retrieval command, and a content display unit configured to arrange the content called by the content calling unit in a 3D space including 3D axes formed based on the metadata.

### CROSS-REFERENCE TO RELATED APPLICATIONS

This application claims priority under 35 U.S.C. §119 to Korean Patent Application No. 10-2013-0129102, filed on Oct. 29, 2013, the disclosure of which is incorporated herein by reference in its entirety.

### TECHNICAL FIELD

The present invention relates to an apparatus and method for browsing content in a 3-dimensional (3D) space.

### BACKGROUND

As storage devices are large-scaled and content compression technologies are evolved, the amount of content stored in the storage devices increases rapidly.

That is, the related art storage device could store at most tens of pieces of content due to limitation in storage or compression technology. However, the advance of technology allows the storage device to store thousands or ten thousands of pieces of content, and thus how efficiently or intuitionally content associated with a search intention among numerous pieces of content can be presented as a search result has been crucial to content browsing (retrieval).

However, the related art technology for arranging content retrieved during a process of browsing the content is used to arrange the content only in a 2D space or, even through used in a 3D space, to simply list the content in the 3D space, and thus has limitations in that the intuition is low and the retrieval is inefficient when numerous pieces of content are browsed.

For example, even when a user intends to retrieve a solution appropriate for a desired inquiry through a knowledge service registered by another person, similar retrieval result content is uniformly listed, and the content should be retrieved and checked only by using a title of the content or using a portion of the content that is simplified and displayed on a display space, thereby significantly reducing efficiency of knowledge service browsing.

Accordingly, when a user browses content, there is a need to provide an efficient browsing service to allow the user to intuitionally and quickly understand and browse a content retrieval result associated with a user's retrieval intention although the number of pieces of content is great.

### SUMMARY

Accordingly, the present invention provides a 3D content browsing apparatus and method that can align and compare pieces of content in a 3D space according to specific criteria and thus increase intuition and efficiency when a user selects content.

In one general aspect, a 3D content browsing apparatus according to the present invention includes an input unit configured to receive content including metadata or a command; a content storage unit configured to receive and store the content input through the input unit; a content calling unit configured to receive a content retrieval command input through the input unit and call the content stored in the content storage unit on the basis of the content retrieval command; and a content display unit configured to arrange the content called by the content calling unit in a 3D space including 3D axes formed based on the metadata.

In another general aspect, a 3D content browsing method according to the present invention includes: performing a content or command input operation of receiving content including metadata or a command; performing a content storage operation of storing the received content; performing a content calling operation of calling the content stored in the content storage operation on the basis of a content retrieval command received in the content or command input operation; and performing a content display operation of arranging the called content in a 3D space on the basis of the metadata.

### BRIEF DESCRIPTION OF THE DRAWINGS

FIG. 1 is a block diagram showing a 3D content browsing apparatus according to the present invention.

FIG. 2 is an exemplary diagram showing a 3D content browsing result according to an embodiment of the present invention.

FIG. 3 is an exemplary diagram showing a 3D content browsing result according to another embodiment of the present invention.

FIG. 4 is an exemplary diagram showing a 3D content browsing result according to still another embodiment of the present invention.

FIG. 5 is a flowchart showing a 3D content browsing method according to the present invention.

FIG. 6 is an exemplary diagram of a computer system implementing an embodiment of the present invention.

### DETAILED DESCRIPTION OF EMBODIMENTS

Hereinafter, a preferred embodiment of an apparatus and method for browsing 3D content according to the present invention will be described in detail with reference to the accompanying drawings. Moreover, detailed descriptions related to well-known functions or configurations will be ruled out in order not to unnecessarily obscure subject matters of the present invention.

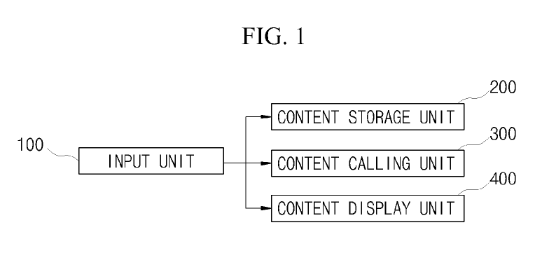

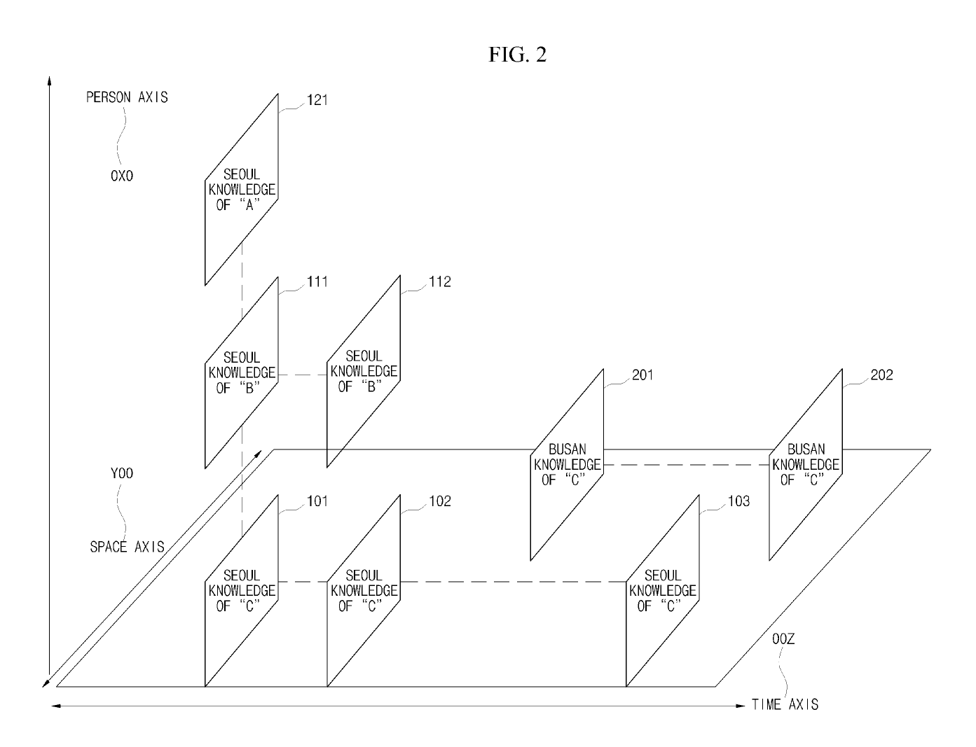

FIG. 1 is a block diagram showing a 3D content browsing apparatus according to the present invention, and FIG. 2 is an exemplary diagram showing a 3D content browsing result according to an embodiment of the present invention.

Referring to FIG. 1, the 3D content browsing apparatus according to the present invention includes an input unit 100 configured to receive a created content or command, a content storage unit 200 configured to receive and store the content input through input unit 100, a content calling unit 300 configured to call the content stored in the content storage unit 200 on the basis of a content retrieval command, and a content display unit 400 configure to arrange the content called by the content calling unit 300 in a 3D space.

In this case, the content input through the input unit 100 includes metadata that is additional data for describing the content, and the content calling unit 300 receives the content retrieval command input through the input unit 100 and calls the content stored in the content storage unit 200 according to the content retrieval command.

In addition, the content display unit 400 arranges and displays the content called by the content calling unit 300 in a 3D space including 3D axes formed based on the metadata of the content.

In this case, the input unit 100 receives content including metadata, such as a creator, a creation area, and a creation time, of the content.

That is, the content display unit 400 designates the creator information, creation area information, and creation time information, which are included in the metadata of the content, as 3D axes, respectively, and arranges and displays the content on the 3D space in consideration of the metadata.

In addition, the content storage unit 200 classifies and stores the content input through the input unit 100 by category on the basis of the metadata.

That is, the content storage unit 200 supports a content grouping function and a content recommendation function of the content display unit 400 by storing content by category, that is, creator, creation area, and creation time, on the basis of the creator information, the creation region information, and the creation time information included in the metadata. The content grouping and content recommendation will be described below.

In addition, the content calling unit 300 calls content associated with a retrieval keyword of the content retrieval command input through the input unit 100, among the content stored in the content storage unit 200 by category on the basis of the metadata.

Referring to FIG. 2 and according to an embodiment of the present invention, if the content retrieval command keyword input through the input unit 100 is “How to learn English”, the content calling unit 300 calls content associated with the keyword, and the content display unit 400 designates creator information, creation area information, and creation time information included in metadata of the content as 3Dimensional axes and displays the content in a 3D space formed by a person axis (creator, 0X0), a space axis (creation area, Y00), and a time axis (creation time, 00Z).

Referring to FIG. 2, the content display unit 400 arranges and displays in a 3D space a knowledge content 101 created by “C” in Seoul on Jan. 13, 2013, a knowledge content 102 created by “C” in Seoul on Apr. 23, 2013, a knowledge content 103 created by “C” in Seoul on Sep. 1, 2013, a knowledge content 201 created by “C” in Busan on Jul. 14, 2013, a knowledge content 202 created by “C” in Busan on Oct. 4, 2013, a knowledge content 111 created by “B” in Seoul on Jan. 13, 2013, a knowledge content 112 created by “B” in Seoul on Apr. 23, 2013, and a knowledge content 121 created by “A” in Seoul on Jan. 13, 2013, which are called by the content calling unit 300, on the basis of creator information, creation area information, and creation time information included in metadata, thereby increasing the intuition when the content are browsed.

In addition, the content display unit 400 may arrange and display the content in consideration of a user preference on the basis of a content browsing preference DB that separately store preferences for the creators (“A”, “B”, and “C”), creation spaces, and creation times of the content, thereby increasing visibility for content including metadata with high preference.

Referring to FIG. 2, if Seoul is highly preferred to Busan with respect to creation area preference in a previously obtained content browsing preference DB, the content created in Seoul is disposed ahead of the content created in Busan in a space axis (Y00) direction, thereby increasing visibility to the content created in Seoul.

In this case, the content may be knowledge content such as “how to learn English” or multimedia content such as a photo or video, and the metadata may be capacity, space, or a folder name.

The content display unit 400 receives a variable limit command input through the input unit 100 and arranges the content in a space having at least one axis selected from among the 3D axes on the basis of the variable limit command.

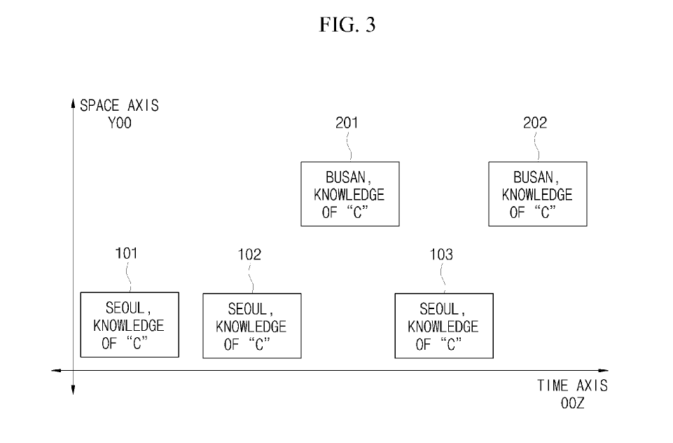

FIG. 3 is an exemplary diagram showing a 3D content browsing result according to another embodiment of the present invention. Referring to FIG. 3, if the metadata of the creator information is fixed as “creator C” in order to browse the knowledge content in only two axes in consideration of specific variables through the input unit 100, the content display unit 400 arranges and displays knowledge content created by creator C in a 2D space having the space axis (creation area, Y00) and the time axis (creation time, 00Z) among three axes forming the 3D space.

If the variable limit command is a space-axis fixing command, the content display unit 400 arranges and displays the knowledge content in a 2D space of the person axis (creator, 0X0) and the time axis (creation time, 00Z) among three axes forming the 3D space. If the variable limit command is a time-axis fixing command, the content display unit 400 arranges and displays the knowledge content in a 2D space of the person axis (creator, 0X0) and the space axis (creation area, 00Z) among three axes forming the 3D space.

That is, according to the present invention, it is possible to select metadata that is a criterion for the content arrangement and select a retrieval axis when a user browses content, thereby preferentially browsing content having metadata of high interest.

In addition, the content display unit 400 receives an axis movement command input through the input unit 100 and moves at least one of the 3D axes on the basis of the axis movement command to display the content.

That is, if a time-axis (creation time, 00Z) movement command is input through the input unit 100, the content display unit 400 browses the content while moving a time axis for content creation time, which is one of metadata of content arranged in the 3D space.

In this case, the content display unit 400 may move only one of the three axes, fix one of the three axes and move the other two axes, or move all the three axes.

In addition, the content display unit 400 receives a reduction or enlargement command input through the input unit 100, reduces or enlarges arrangement of the content on the basis of the reduction or enlargement command, and then displays the content.

That is, when the enlargement command is input through the input unit 100, the number of pieces of content displayed in a display screen where content is arranged and displayed in the 3D space by the content display unit 400 is reduced, but it is possible to display content information in detail. When the reduction command is input through the input unit 100, the content display unit 400 displays more pieces of content in the display screen.

In addition, the content display unit 400 recommends the content called by the content calling unit 300 if the number of times the content has been selected is equal to or greater than a predetermined value.

That is, the content storage unit 200 stores the number of times other users have selected the content, and the content display unit 400 arranges the content called on the basis of the keyword of the retrieval command in a 3D space and recommends and displays the content if the number of times other users has selected the content is equal to or greater than a predetermined value (for example, 20).

In this case, the content display unit 400 displays the recommended content using a separate color and arranges the content in a 3D space, or displays the recommended content using a separate sign.

In addition, the content display unit 400 groups and displays content created by the same content creator among the content called by the content calling unit 300.

In this case, if the number of pieces of content created by the same content creator is equal to or greater than a predetermined value, the content display unit 400 groups and displays the content.

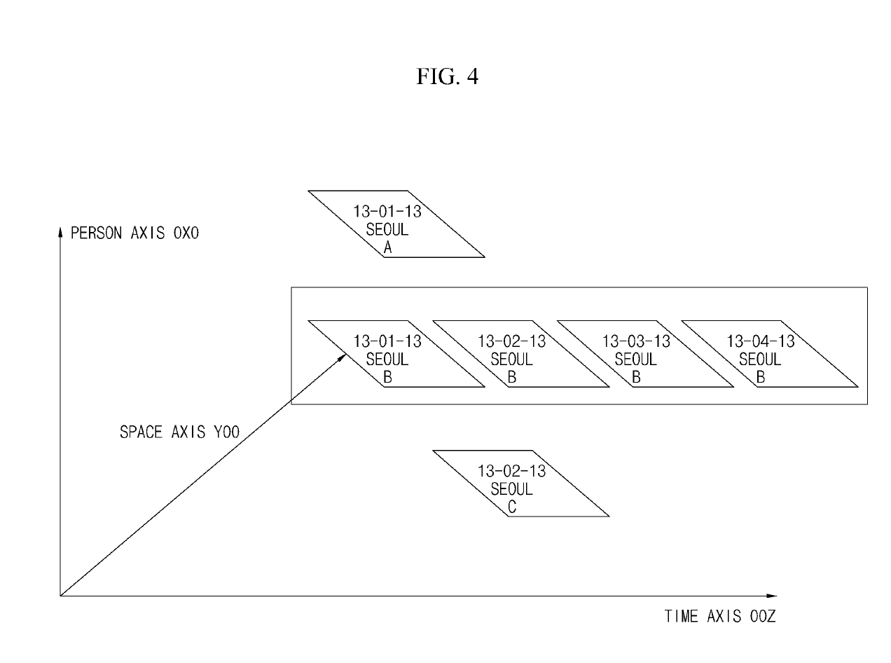

FIG. 4 is an exemplary diagram showing a 3D content browsing result according to still another embodiment of the present invention. Referring to FIG. 4, the content display unit 400 arranges and displays content created by “A” in Seoul on Jan. 13, 2013, content created by “B” in Seoul on Jan. 23, Feb. 13, Mar. 13, and Apr. 13, 2013, and content created by “C” in Seoul on Feb. 13, 2013, which are called by the content calling unit 300, in a 3D space.

If the predetermined value is 4, the content display unit 400 groups and displays content created by “B”, the number of which is equal to or greater than 4, among the content created by the same creator.

That is, the content display unit 400 separately groups and displays content created by the content creator who creates many pieces of content, thereby increasing the user intuition and easily browsing information about content creators who creates many pieces of content.

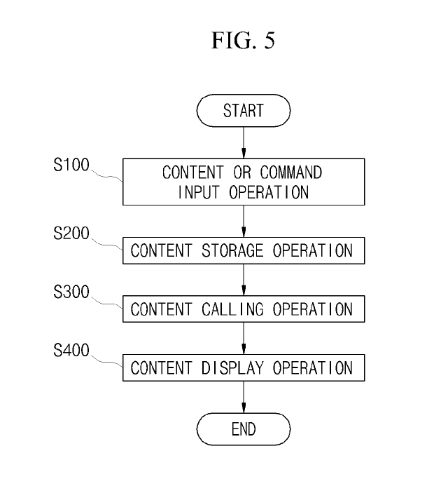

FIG. 5 is a flowchart showing a 3D content browsing method according to the present invention.

Referring to FIG. 5, the 3D content browsing method according to the present invention includes a content or command input operation S100 of receiving content including metadata or a command; a content storage operation S200 of storing the received content; a content calling operation S300 of calling the content stored in the content storage operation S200 on the basis of a content retrieval command received in the content or command input operation S100; and a content display operation S400 of arranging the called content in a 3D space on the basis of the metadata.

In this case, the content or command input operation S100 receives the content including the metadata such as, a creator, creation area, and creation time of the content.

In addition, the content storage operation S200 classifies and stores the received content by category on the basis of the metadata included in the content.

That is, the content storage operation S200 classifies and stores the content by category on the basis of the metadata included in the content, such as a creator, creation area, and creation time of the content.

In addition, the content calling operation S300 calls content associated with a retrieval keyword of the content retrieval command among the content classified and stored by category in operation S200.

In addition, the content display operation S400 designates the creator, creation area, and creation time of the content, which are included in the metadata of the content, as 3D axes and arranges and displays the content in a 3D space formed by the 3D axes.

That is, the content display operation S400 forms the 3D space using the axes for the metadata of the content and arranges and displays the content in the 3D space in consideration of the metadata of the content stored in the content storage operation S200.

In addition, when a variable limit command is input in the content or command input operation S100, the content display operation S400 receives the input variable limit command, creates a space formed by at least one axis selected from among the 3D axes forming the 3D space according to the variable limit command, and arranges the content in the created space.

That is, if the variable limit command is a two-axis selection command, the content display operation S400 arranges and displays the content in a 2D plane formed by the selected two axes.

In addition, when an axis movement command is input in the content or command input operation S100, the content display operation S400 receives the input axis movement command and moves and displays at least one of the 3D axes forming the 3D space according to the axis movement command.

In addition, when a reduction or enlargement command is input in the content or command input operation S100, the content display operation S400 reduces an arrangement of the content in the 3D space according to the reduction or enlargement command to display a larger number of pieces of content in a screen where the content is displayed, and enlarges the arrangement of the content in the 3D space according to the reduction or enlargement command to display a smaller number of pieces of content in the screen and display information about the content in detail.

In addition, in consideration of a content selection number included in the called content, the content display operation S400 recommends and displays the content if the selection number is equal to or greater than a predetermined value.

That is, the content display operation S400 recommends the content with a separate sign if the number of times the content has been selected is equal to or greater than the predetermined value (for example, 20) as retrieval history information for the called content.

In addition, the content display operation S400 groups and displays content having the same content creator among the called content. In this case, considering the number of pieces of content having the same content creator, the content display operation S400 groups the content if the number is equal to or greater than the predetermined value.

That is, if the number of pieces of content created by the content creator (for example, “A”) is equal to or greater than a predetermined value (for example, 4), the content created by the same content creator are grouped and displayed, and thus the content created by a creator who creates the content many times may be displayed separately.

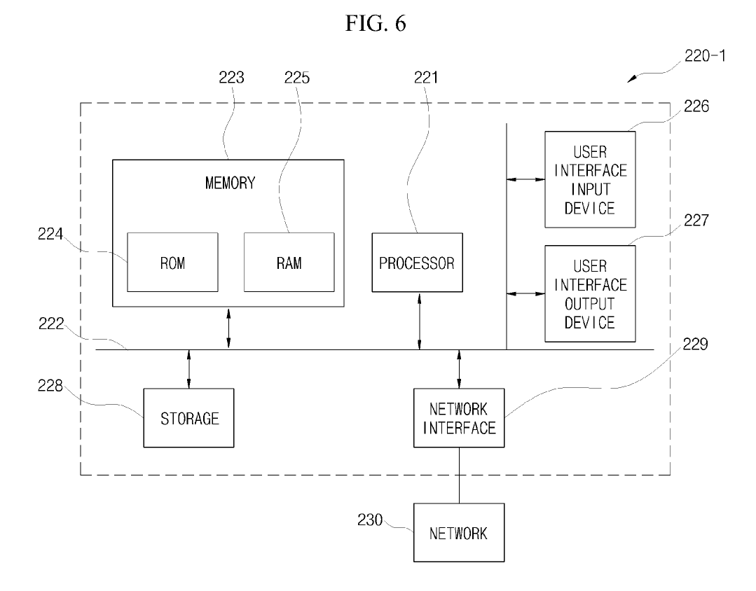

An embodiment of the present invention may be implemented in a computer system, e.g., as a computer readable medium. As shown in in FIG. 6, a computer system 220-1 may include one or more of a processor 221, a memory 223, a user input device 226, a user output device 227, and a storage 228, each of which communicates through a bus 222. The computer system 220-1 may also include a network interface 229 that is coupled to a network. The processor 221 may be a central processing unit (CPU) or a semiconductor device that executes processing instructions stored in the memory 223 and/or the storage 228. The memory 223 and the storage 228 may include various forms of volatile or non-volatile storage media. For example, the memory may include a read-only memory (ROM) 224 and a random access memory (RAM) 225.

Accordingly, an embodiment of the invention may be implemented as a computer implemented method or as a non-transitory computer readable medium with computer executable instructions stored thereon. In an embodiment, when executed by the processor, the computer readable instructions may perform a method according to at least one aspect of the invention.

The 3D content browsing apparatus and method according to the present invention can control the arrangement of content according to specific criteria when the content is provided in a 3D environment, thereby browsing the content in various ways.

According to the present invention, it is also possible to arrange the content in the 3D space according to predetermined metadata, thereby increasing intuition of content retrieval.

According to the present invention, it is also possible to select metadata that is a criterion for the content arrangement and thus arrange the content for metadata of high interest, thereby increasing convenience of content retrieval.

According to the present invention, it is also possible to recommend content having a selection number that is equal to or greater than a predetermined value in consideration of the selection number that is retrieved for the content when the content is arranged in the 3D space, thereby providing the recommendation of useful content, which is retrieved many times.

This invention has been particularly shown and described with reference to preferred embodiments thereof. It will be understood by those skilled in the art that various changes in form and details may be made therein without departing from the spirit and scope of the invention as defined by the appended claims. Accordingly, the referred embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. A 3D content browsing apparatus comprising:
an input unit configured to receive content including metadata or a command;
a content storage unit configured to receive and store the content input through the input unit;
a content calling unit configured to receive a content retrieval command input through the input unit and call the content stored in the content storage unit on the basis of the content retrieval command; and
a content display unit configured to arrange the content called by the content calling unit in a 3D space including 3D axes formed based on the metadata.

2. The 3D content browsing apparatus of claim 1, wherein the input unit receives the content including the metadata, such as a creator, a creation area, and a creation time, of the content.

3. The 3D content browsing apparatus of claim 1, wherein the content storage unit classifies and stores the input content by category on the basis of the metadata included the content.

4. The 3D content browsing apparatus of claim 1, wherein the content calling unit calls content associated with a retrieval keyword of the content retrieval command among the content classified and stored by category by the content storage unit.

5. The 3D content browsing apparatus of claim 2, wherein the content display unit designates the creator, creation area, and creation time of the content as 3D axes and arranges the content in the 3D space in consideration of the metadata.

6. The 3D content browsing apparatus of claim 1, wherein the content display unit receives a variable limit command input through the input unit and arranges the content in a space formed by one axis selected from among the 3D axes.

7. The 3D content browsing apparatus of claim 1, wherein the content display unit receives an axis movement commend input through the input unit and moves at least one of the 3D axes to display the content on the basis of the axis movement commend.

8. The 3D content browsing apparatus of claim 1, wherein the content display unit receives a reduction or enlargement command input through the input unit 100 and reduces or enlarges an arrangement of the content to display the content on the basis of the reduction or enlargement command.

9. The 3D content browsing apparatus of claim 1, wherein the content display unit recommends content having a selection number equal to or greater than a predetermined value among the content called by the content calling unit.

10. The 3D content browsing apparatus of claim 2, wherein the content display unit groups and displays content having the same content creator among the content called by the content calling unit and the grouped content is selected in consideration of the number of pieces of content having the same content creator.

11. A 3D content browsing method comprising:
performing a content or command input operation of receiving content including metadata or a command;
performing a content storage operation of storing the received content;
performing a content calling operation of calling the content stored in the content storage operation on the basis of a content retrieval command received in the content or command input operation; and
performing a content display operation of arranging the called content in a 3D space on the basis of the metadata.

12. The 3D content browsing method of claim 11, wherein the content or command input operation comprises receiving the content including the metadata, such as a creator, a creation area, and a creation time, of the content.

13. The 3D content browsing method of claim 11, wherein the content storage operation comprises classifying and storing the content by category on the basis of the metadata included in the received content.

14. The 3D content browsing method of claim 13, wherein the content calling operation comprises calling content associated with a retrieval keyword of the content retrieval command among the content classified and stored by category in the content storage operation.

15. The 3D content browsing method of claim 12, wherein the content display operation comprises designating the creator, creation area, and creation time of the content as 3D axes and arranging the content in the 3D space in consideration of the metadata.

16. The 3D content browsing method of claim 11, wherein the content display operation comprises receiving a variable limit command, creating a space forming at least one axis selected from among the 3D axes forming the 3D space according to the variable limit command, and arranging the content in the created space.

17. The 3D content browsing method of claim 11, wherein the content display operation comprises receiving an axis movement commend and moves at least one of the 3D axes forming the 3D space to display the content on the basis of the axis movement commend.

18. The 3D content browsing method of claim 11, wherein the content display operation comprises receiving a reduction or enlargement command and reduces or enlarges an arrangement of the content to display the content on the basis of the reduction or enlargement command.

19. The 3D content browsing method of claim 11, wherein the content display operation comprises recommending content having a selection number equal to or greater than a predetermined value in consideration of the selection number previously obtained for the called content.

20. The 3D content browsing method of claim 12, wherein the content display operation comprises grouping and displaying content having the same content creator in consideration of the number of pieces of content having the same content creator, among the called content.
